(19) United States
(12) Patent Application Publication
(10) Pub. No.: US 2023/0421398 A1
(43) Pub. Date: Dec. 28, 2023

(54) SYSTEM AND METHOD FOR INSERTING TRANSACTIONS INTO TRANSACTION POOLS

(71) Applicants: Vilma Mattila, London (GB); Pratik Gauri, London (GB); Prateek Dwivedi, London (GB)

(72) Inventors: Vilma Mattila, London (GB); Pratik Gauri, London (GB); Prateek Dwivedi, London (GB)

(73) Assignee: 5ire LLP, London (GB)

(21) Appl. No.: 17/850,563

(22) Filed: Jun. 27, 2022

(51) Int. Cl. H04L 9/00; H04L 9/32

(52) U.S. Cl. CPC H04L 9/50; H04L 9/3236; H04L 9/006

(57) ABSTRACT

A computer-implemented system and method for inserting transactions into transaction pools are disclosed. The system comprises a blockchain transaction pool management system having a computing device having a non-transitory memory and one or more processors coupled to the non-transitory memory to execute a set of instructions configured to insert transactions into transaction pools. The blockchain transaction pool management system uses multiple transaction pools for inserting a new transaction into a respective transaction pool. The computing device is configured to generate a hash output value for a public key of a sender of the new transaction using a standard hash function; compare the starting bits of the hash output value to a unique serial number or identification (ID) number of the transaction pools, and store the new transaction under the transaction pool having the ID number that matches with the starting bits of the hash output value without overlapping other transactions.

### FIELD OF THE INVENTION

The present invention generally relates to blockchain technology. More specifically, the present invention relates to a computer-implemented system and method for processing and inserting transactions under any of a respective transaction pool among multiple transaction pools by validating concurrent blocks without overlapping other transactions.

### BACKGROUND

With the development of computer technology, more and more technologies, for example, blockchain technology, are applied in the financial field. Blockchain is a shared, immutable ledger that facilitates the process of recording transactions and tracking assets in a business network. The traditional financial industry is gradually changing its financial technology to modern advanced technologies for secured transactions. Currently, transactions are often conducted through block links in the field of financial technology based on their non-tamper-ability. The transactions are classified and stored under any one of the different types of transaction pools. The transaction pool is a data structure that contains all of the unconfirmed transactions. The transaction pool is stored on a special device and its contents can be accessed, observed in real-time.

Few existing patent references attempt to address the problems cited in the background as prior art over the presently disclosed subject matter are explained as follows:

A prior art WO 2020142907 A1 to Zhang Jiheng, et. al., entitled “Method and apparatus for creating and adding block based on structured directed acyclic graph, and method and apparatus for establishing account book” discloses a method and apparatus for creating and adding a block based on a structured directed acyclic graph, and a method and apparatus for establishing a distributed account book. A chain structure is extended to a DAG while a proof-of-work (PoW) mechanism and a Nakamoto consensus method are used, so as to achieve the technical effects of expanding the capacity, shortening the latency, and implementing mining hash rate decentralization, and increasing the processing opportunity of transactions with low fees without sacrificing security and decentralization.

Another prior art U.S. Ser. No. 11/082,237 B2 to Ning Xia, entitled “Accelerating transaction deliveries in blockchain networks using transaction resending” discloses a blockchain transaction acceleration system that receives a first transaction sent through a first node in a blockchain. At least one second transaction that is a duplicate of the first transaction is received in the blockchain transaction acceleration system, where the at least one second transaction sent by the first node to at least one second node in the blockchain is different from the first node. The blockchain transaction acceleration system executes a first-received transaction among received transactions that include the first transaction and the at least one second transaction. Upon determining, by the blockchain transaction acceleration system, that remaining transactions of the received transactions are identical to the first-received transaction, discarding the remaining transactions.

Another prior art WO 2021184885 A1 to Lin Peng, entitled “Method and device for use in updating public key set at blockchain node” discloses a method for use in updating a public key set at a blockchain node, the public key set comprising public keys of all blockchain nodes participating in a consensus in a blockchain network. The method comprises: with respect to at least one newly added block, determining, on the basis of receipt index information and a node change-type transaction identifier in a block header of the block, whether a node change-type transaction indicated by the node change-type transaction identifier is present in the block, the receipt information comprising a transaction type identifier field; when the node change-type transaction is present in the block, acquiring block body information of the bloc); acquiring receipt information of the node change-type transaction in the block body information), the receipt information comprising a public key field, the public key field being used for storing a public key of a changed blockchain node indicated by the node change-type transaction; acquiring the public key of the changed blockchain node from the public key field of the receipt information; and utilizing the acquired public key to update a public key set.

Though the above existing prior art discloses various methods, systems, and techniques to facilitate storing of multiple transactions under multiple transaction pools, none of them disclose about the insertion of transactions into a respective transaction pool among several distinct transaction pools depending upon the first log n bits of the hash value of the public key of the sender in transaction. Also, they lack to disclose a system and method that validate the concurrent blocks without overlapping transactions.

In light of the above-mentioned drawback, there is a need for a system and method for processing and inserting transactions under any of a respective transaction pool by validating concurrent blocks without overlapping other transactions. Also, there is a need for a system and method for validating concurrent blocks in the blockchain network without overlapping other transactions.

### SUMMARY OF THE INVENTION

The present invention generally discloses a computer-implemented system and method for inserting transactions into transaction pools. Also, the present invention discloses a system and method for processing and inserting transactions under any of a respective transaction pool among multiple transaction pools by validating concurrent blocks without overlapping other transactions.

In one embodiment, the system of a sustainability-driven blockchain or firechain or 5irechain is executed in a network environment for inserting transactions into multiple transaction pools. The system runs in the computer-implemented network environment configured to process and insert the transactions into respective transaction pools. The system supports multiple smaller chains that may branch out from a main blockchain network. The multiple smaller chains progress separately. In one embodiment, the multiple smaller chains are merged to form a base of the firechain and its scalability. In one embodiment, the system processes transactions using one or more nodes to create concurrent blocks and maintains smaller chains forming the base of the firechain and scalability. In one embodiment, the system is an application software or web-based application or mobile application or desktop application.

In one embodiment, the network environment comprises one or more user devices. Each user device is associated with a user. In one embodiment, the user device is installed with the application software. The system further comprises a network and a blockchain transaction pool management system. In one embodiment, the user device is enabled to access the blockchain transaction pool management system via the network. In one embodiment, the user device enables the user to access one or more services provided by the system. In one embodiment, the user device is at least any one of a smartphone, a mobile phone, a tablet, a laptop, a desktop, and/or other suitable hand-held electronic communication devices. In one embodiment, the user device comprises a storage medium in communication with the network to access the blockchain transaction pool management system. In an embodiment, the network could be Wi-Fi, WiMAX, wireless local area network (WLAN), satellite networks, cellular networks, private networks, and the like.

In one embodiment, the blockchain transaction pool management system comprises a computing device and one or more databases in communication with the computing device. In one embodiment, the computing device is a server. In one embodiment, the computing device could be a cloud server. In one embodiment, the server could be operated as a single computer. In some embodiments, the computer could be a touchscreen and/or non-touchscreen and adopted to run on any type of OS, such as iOS™ Windows™, Android™, Unix™, Linux™, and/or others. In one embodiment, the plurality of computers is in communication with each other, via networks. Such communication is established via any one of an application software, a mobile application, a browser, an OS, and/or any combination thereof.

In one embodiment, the database is in communication with the computing device via the network. In one embodiment, the database is accessible by the computing device. In another embodiment, the database is integrated into the computing device or separate from it. In one embodiment, the computing device comprises a computer-readable medium or memory unit and one or more processors coupled to the computer-readable medium. The memory unit stores a set of instructions executable by the processor configured to process transactions using nodes. The memory unit could be RAM, ROM (including EPROM, EEPROM, PROM). In one embodiment, the user devices are configured to access the services provided by the computing device via the network. In one embodiment, the computing device is configured to process the transactions and insert them into transaction pools.

In one embodiment, the firechain ecosystem uses multiple transaction pools. In one embodiment, one transaction pool is associated with one chain. In one embodiment, each transaction pool comprises a unique serial number or identification (ID) number. If a new transaction appears in the main blockchain network, then the new transaction will go to any one of these transaction pools. If there are n-transaction pools, then the new transaction “Tr” will go to one of these transaction pools depending upon the first log n-bits of a hash value of the public key of the sender in “Tr”. For example, if the numeric value of the first log n-bits of the hash value of the public key of the sender in “Tr” is k, then the new transaction “Tr” will go to the transaction pool k. In one embodiment, the new transaction is inserted into any one of the respective transaction pools depending upon the first log n-bits of the hash value of the public key of the sender in the transaction.

At first, a hash output value for the public key of the sender of the new transaction is generated using a standard hash function, for example, SHA-256. Then the starting bits of the hash output value are compared to a unique serial number or identification (ID) number of the transaction pools. In one embodiment, the first three bits of the hash output are chosen. Finally, the transaction goes into the transaction pool whose id matches the first three bits of the hash output. In one embodiment, the new transaction “T18” is stored under the transaction pool having the ID number that matches with the starting bits of the hash output value without overlapping other transactions. In one embodiment, the transactions will be stored in different transaction pools based on the starting bits of the hash of transactions. This will allow the user to validate the concurrent blocks without overlapping transactions.

In one embodiment, a method uses a computer-implemented system of a sustainability-driven blockchain platform or firechain executed in a network environment for inserting a new transaction into any one of the respective transaction pools among multiple transaction pools. The system comprises a blockchain transaction pool management system comprising a computing device. The computing device comprises a non-transitory memory and one or more processors coupled to the non-transitory memory configured to read one or more instructions from the non-transitory memory to process transactions at scale. In one embodiment, the blockchain transaction pool management system further comprises one or more databases in communication with the computing device via a network configured to store a plurality of transactions and transaction pool details.

In one embodiment, the blockchain transaction pool management system uses multiple transaction pools for inserting transactions. In one embodiment, the method of inserting a new transaction into a respective transactions pool comprises the following steps. At one step, a hash output value for a public key of a sender of the new transaction is generated using a standard hash function. At another step, the starting bits of the hash output value are compared to a unique serial number or identification (ID) number of the transaction pools. In one embodiment, the first three bits of the hash output are chosen to compare with the ID of the transaction pools to find the match for the first three bits of the hash output.

At another step, the new transaction is stored under the transaction pool having the ID number that matches with the starting bits of the hash output value without overlapping other transactions. In one embodiment, the blockchain transaction pool management system creates one or more concurrent blocks for storing transactions and generates one or more smaller chains using the blocks. In one embodiment, the one or more smaller chains are merged to form a base of the firechain and scalability. Further, the system allows validation of the concurrent blocks without overlapping the transactions.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a computer-implemented system executed in a network environment for processing transactions using transaction pools in a sustainability-driven blockchain platform or firechain ecosystem in an embodiment of the present invention.

FIG. 2 shows a block diagram illustrating a process of inserting transactions into multiple transaction pools in the firechain ecosystem in one embodiment of the present invention.

FIG. 3 shows a method of inserting a new transaction into a respective transaction pool in one embodiment of the present invention.

### DETAILED DESCRIPTION OF EMBODIMENTS

The present invention is best understood by reference to the detailed figures and description set forth herein.

It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

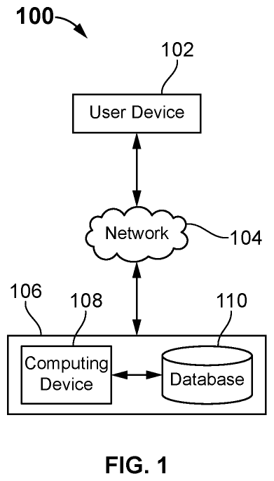

Referring to FIG. 1, a computer-implemented system of a sustainability-driven fifth-generation blockchain or firechain or 5irechain or 5ire ecosystem executed in a network environment 100 for inserting transactions into transaction pools, according to one embodiment of the present invention. The system runs in the computer-implemented network environment 100 configured to process and insert the transactions into respective transaction pools. The system supports multiple smaller chains that may branch out from a main blockchain network. The multiple smaller chains progress separately. In one embodiment, the multiple smaller chains are merged to form a base of the firechain and its scalability. In one embodiment, the system processes transactions using one or more nodes to create concurrent blocks and maintains smaller chains forming the base of the firechain. In one embodiment, the system is an application software or web-based application or mobile application or desktop application.

In one embodiment, the network environment 100 comprises one or more user devices 102. Each user device 102 is associated with a user. In one embodiment, the user device 102 is installed with the application software. The system further comprises a network 104 and a blockchain transaction pool management system 106. In one embodiment, the user device 102 is enabled to access the blockchain transaction pool management system 106 via the network 104. In one embodiment, the user device 102 enables the user to access one or more services provided by the system. In one embodiment, the user device 102 is at least any one of a smartphone, a mobile phone, a tablet, a laptop, a desktop, and/or other suitable hand-held electronic communication devices. In one embodiment, the user device 102 comprises a storage medium in communication with the network 104 to access the blockchain transaction pool management system 106. In an embodiment, the network 104 could be Wi-Fi, WiMAX, wireless local area network (WLAN), satellite networks, cellular networks, private networks, and the like.

In one embodiment, the blockchain transaction pool management system 106 comprises a computing device 108 and one or more databases 110 in communication with the computing device 108. In one embodiment, the computing device 108 is a server. In one embodiment, the computing device 108 could be a cloud server. In one embodiment, the server could be operated as a single computer. In some embodiments, the computer could be a touchscreen and/or non-touchscreen and adopted to run on any type of OS, such as iOS™, Windows™, Android™, Unix™, Linux™, and/or others. In one embodiment, the plurality of computers is in communication with each other, via networks. Such communication is established via any one of an application software, a mobile application, a browser, an OS, and/or any combination thereof.

In one embodiment, the database 110 is in communication with the computing device 108 via the network 104. In one embodiment, the database 110 is accessible by the computing device 108. In another embodiment, the database 110 is integrated into the computing device 108 or separate from it. In some embodiments, the database 110 resides in a connected server or a cloud computing service. Regardless of location, the database 110 comprises a memory to store and organize certain data for use by the computing device 108.

In one embodiment, the computing device 108 comprises a computer-readable medium or memory unit and one or more processors coupled to the computer-readable medium. The memory unit stores a set of instructions executable by the processor configured to process transactions using nodes. The memory unit could be RAM, ROM (including EPROM, EEPROM, PROM). In one embodiment, the user devices 102 are configured to access the services provided by the computing device 108 via the network 104. In one embodiment, the computing device 108 is configured to process the transactions and insert them into transaction pools.

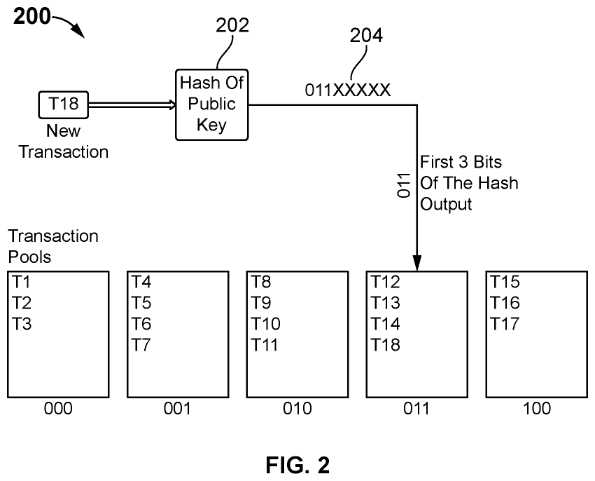

Referring to FIG. 2, a block diagram 200 illustrates a process of inserting transactions into multiple transaction pools in the firechain ecosystem, according to one embodiment of the present invention. In one embodiment, the firechain ecosystem supports multiple smaller chains that may branch out from the main blockchain network. The multiple smaller chains progress separately. In one embodiment, the multiple smaller chains are merged to form a base of the firechain and its scalability.

In one embodiment, the firechain ecosystem uses multiple transaction pools. In one embodiment, one transaction pool is associated with one chain. In one embodiment, each transaction pool comprises a unique serial number or identification (ID) number. If a new transaction appears in the main blockchain network, then the new transaction will go to any one of these transaction pools. If there are n-transaction pools, then the new transaction “Tr” will go to one of these transaction pools depending upon the first log n-bits of a hash value of public key 202 of the sender in “Tr”. For example, if the numeric value of the first log n-bits of the hash value of the public key 202 of the sender in “Tr” is k, then the new transaction “Tr” will go to the transaction pool k.

Let, there are n distinct transaction pools. These transaction pools have numbers between 0 and n−1. When a new transaction “Tx” appears, it goes to the pool F(Tx)[0, n−1]. Here,

F(Tx)=i=1 log n2 log n−1I[256−i]

and

I[255:0]=SHA−256PTx

Here, PTx is the public key of the transaction sender.

According to FIG. 2, the firechain network comprises five distinct transaction pools. Each transaction pool has a unique serial number or identification (ID) number. In one embodiment, the IDs of the five transaction pools are 000, 001, 010, 011, and 100. Each transaction pool has one or more transactions. The transaction pool 000 has multiple transactions including T1, T2, and T3. The transaction pool 001 has multiple transactions including T4, T5, T6, and T7. The transaction pool 010 has multiple transactions including T8, T9, T10, and T11. The transaction pool 011 has multiple transactions including T12, T13, and T14. The transaction pool 100 has multiple transactions including T15, T16, and T17. A new transaction “T18” appears in the network. The new transaction “T18” is inserted into any one of the respective transaction pools depending upon the first log n-bits of the hash value of public key 202 of the sender in the transaction. At first, a hash output value “011XXXXX” 204 for the public key 202 of the sender of the new transaction is generated using a standard hash function, for example, SHA-256. Then the starting bits of the hash output value 204 are compared to a unique serial number or identification (ID) number of the transaction pools. In one embodiment, the first three bits of the hash output “011XXXXX” 204 are chosen. Finally, the transaction goes into the transaction pool whose id matches the first three bits of the hash output 204. In one embodiment, the new transaction “T18” is stored under the transaction pool having the ID number that matches with the starting bits of the hash output value “011XXXXX” 204 without overlapping other transactions. For example, the first three bits of the hash output “011XXXXX” 204 is 011, hence, the new transaction “T18” is added to the transaction pool 011. In one embodiment, the transactions will be stored in different transaction pools based on the starting bits of the hash of transactions. This will allow the user to validate the concurrent blocks without overlapping transactions.

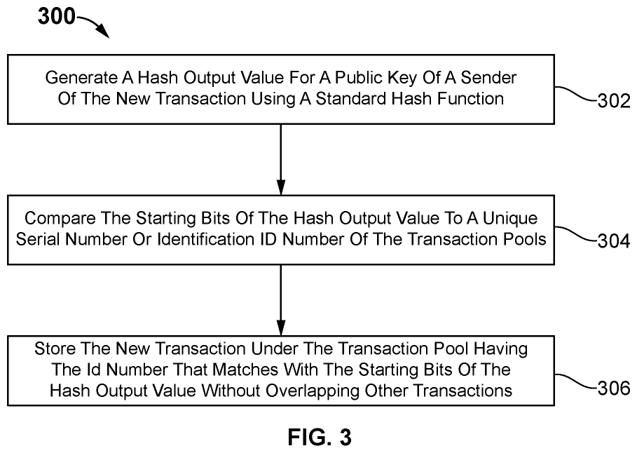

Referring to FIG. 3, a method 300 of adding/inserting transactions into transaction pools, according to one embodiment of the present invention. In one embodiment, the method 300 uses a computer-implemented system of a sustainability-driven blockchain platform or firechain executed in a network environment for inserting a new transaction into any one of the respective transaction pools among multiple transaction pools. The system comprises a blockchain transaction pool management system 106 comprising a computing device 108. The computing device 108 comprises a non-transitory memory and one or more processors coupled to the non-transitory memory configured to read one or more instructions from the non-transitory memory to process transactions at scale. In one embodiment, the blockchain transaction pool management system 106 further comprises one or more databases 110 in communication with the computing device 108 via a network 104 configured to store a plurality of transactions and transaction pool details.

In one embodiment, the blockchain transaction pool management system 106 uses multiple transaction pools for inserting transactions. In one embodiment, the method 300 of inserting a new transaction into a respective transactions pool comprises the following steps. At step 302, a hash output value 204 for a public key 202 of a sender of the new transaction is generated using a standard hash function. At step 304, the starting bits of the hash output value are compared to a unique serial number or identification (ID) number of the transaction pools. In one embodiment, the first three bits of the hash output 204 are chosen to compare with the ID of the transaction pools to find the match for the first three bits of the hash output 204. At step 306, the new transaction is stored under the transaction pool having the ID number that matches with the starting bits of the hash output value without overlapping other transactions.

In one embodiment, the blockchain transaction pool management system 106 creates one or more concurrent blocks for storing transactions and generates one or more smaller chains using the blocks. In one embodiment, the one or more smaller chains are merged to form a base of the firechain and scalability. Further, the system allows validation of the concurrent blocks without overlapping the transactions.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A computer-implemented system of a sustainability-driven blockchain platform or firechain executed in a network environment for inserting transactions into transaction pools, comprising:
a blockchain transaction pool management system comprising a computing device having a non-transitory memory and one or more processors coupled to the non-transitory memory configured to read one or more instructions from the non-transitory memory to process transactions and one or more databases in communication with the computing device via a network configured to store a plurality of transactions and transaction pool details,
wherein the blockchain transaction pool management system uses multiple transaction pools for inserting a new transaction into a respective transaction pool, wherein the computing device of the blockchain transaction pool management system is configured to,
generate a hash output value for a public key of a sender of the new transaction using a standard hash function;
compare the starting bits of the hash output value to a unique serial number or identification (ID) number of the transaction pools, and
store the new transaction under the transaction pool having the ID number that matches with the starting bits of the hash output value without overlapping other transactions.

2. The system of claim 1, creates concurrent blocks for storing transactions and generates one or more smaller chains using the blocks.

3. The system of claim 2, wherein the one or more smaller chains are merged to form a base of the firechain and its scalability.

4. The system of claim 1, allows validation of the concurrent blocks without overlapping the transactions.

5. The system of claim 1, further comprises at least one user device configured to communicate with the computing device via the network using an application software or mobile application or web-based application or desktop application executed in the network environment.

6. The system of claim 5, wherein the user device is any one of a mobile phone, a smart phone, a tablet, a laptop, a desktop, and/or other suitable hand-held electronic communication devices.

7. The system of claim 1, wherein the computing device is a cloud server.

8. The system of claim 1, wherein the network is any one of Wi-Fi, WiMAX, wireless local area network (WLAN), satellite networks, cellular networks, private networks, or other suitable communication networks.

9. A method of adding/inserting transactions into transaction pools using a computer-implemented system of a sustainability-driven blockchain platform or firechain executed in a network environment, comprises of a blockchain transaction pool management system comprising a computing device having a non-transitory memory and one or more processors coupled to the non-transitory memory configured to read one or more instructions from the non-transitory memory to process transactions and one or more databases in communication with the computing device via a network configured to store a plurality of transactions and transaction pool details,
wherein the blockchain transaction pool management system uses multiple transaction pools for inserting transactions, wherein the method of inserting a new transaction into a respective transactions pool comprises the steps of,
generating a hash output value for a public key of a sender of the new transaction using a standard hash function;
comparing the starting bits of the hash output value to a unique serial number or identification (ID) number of the transaction pools, and
storing the new transaction under the transaction pool having the ID number that matches with the starting bits of the hash output value without overlapping other transactions.

10. The method of claim 9, wherein the blockchain transaction pool management system creates one or more concurrent blocks for storing transactions and generates one or more smaller chains using the blocks.

11. The method of claim 10, wherein the one or more smaller chains are merged to form a base of the firechain and scalability.

12. The method of claim 9, wherein the system allows validation of the concurrent blocks without overlapping the transactions.
